(19) United States
(12) Patent Application Publication
(10) Pub. No.: US 2013/0110468 A1
(43) Pub. Date: May 2, 2013

(54) ELECTRONIC DEVICE AND METHOD FOR CREATING MEASUREMENT CODES

(71) Applicants: CHIH-KUANG CHANG, Tu-Cheng (TW); XIN-YUAN WU, Shenzhen City (CN); WEI-QUAN WU, Shenzhen City (CN)

(72) Inventors: CHIH-KUANG CHANG, Tu-Cheng (TW); XIN-YUAN WU, Shenzhen City (CN); WEI-QUAN WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/539,542

(22) Filed: Jul. 2, 2012

(30) Foreign Application Priority Data
Oct. 28, 2011 (CN) 201110333533.8

(51) Int. Cl. G06F 17/50

(52) U.S. Cl. 703/1

(57) ABSTRACT

A method for creating measurement codes automatically using an electronic device. One or more feature elements are selected in a three dimensional (3D) image of an object. The method determines measured types of the feature elements and output axes of each feature element according to an attribute type and a measurement type of each feature element. The method further draws the feature elements in a two dimensional (2D) image of the object, sets a relation graph beside each feature element, assign a graph number to each relation graph, receives a graph number of a relation graph, determines a marked number corresponding to the graph number, obtains a reference value, an upper tolerance, and a lower tolerance of each feature element, and creates measurement codes of each feature element according to the obtained information.

### BACKGROUND

1. Technical Field

Embodiments of the present disclosure relate to measurement technology, and particularly to an electronic device and method for creating measurement codes using the electronic device.

2. Description of Related Art

Measurement is an important phase in manufacturing and is closely related to product quality. Point cloud obtaining devices have been used to obtain a point cloud of an object by scanning a large number of points on a surface of the object, processing the data in the point cloud, and subsequently extracting boundary elements including boundary points and boundary characteristics of the object, in order to form an image of the profile of the object.

Image measurement system has been used to measure the object by analyzing form and position tolerances of the object, for example, analyzing feature elements (e.g., lines or points) of the object. However, many image measuring methods cannot automatically create the measurement codes of a measured object. It is necessary to find feature elements need to be measured from a three dimensional (3D) image of the object first, select the feature elements need to be measured from a two dimensional (2D) user interface manually (referring to FIG. 1), and manually select measurement parameters, such as a type of measurement (e.g. a location), an output axis (e.g., an X-axis) and a tolerance range of the feature element to output the desired measurement data. Therefore, a more efficient method for creating the measurement code of the object is desired.

### BRIEF DESCRIPTION OF THE DRAWINGS

FIG. 1 is a schematic diagram of one embodiment of a user interface used to select feature elements to be measured and measurement parameters in a prior art.

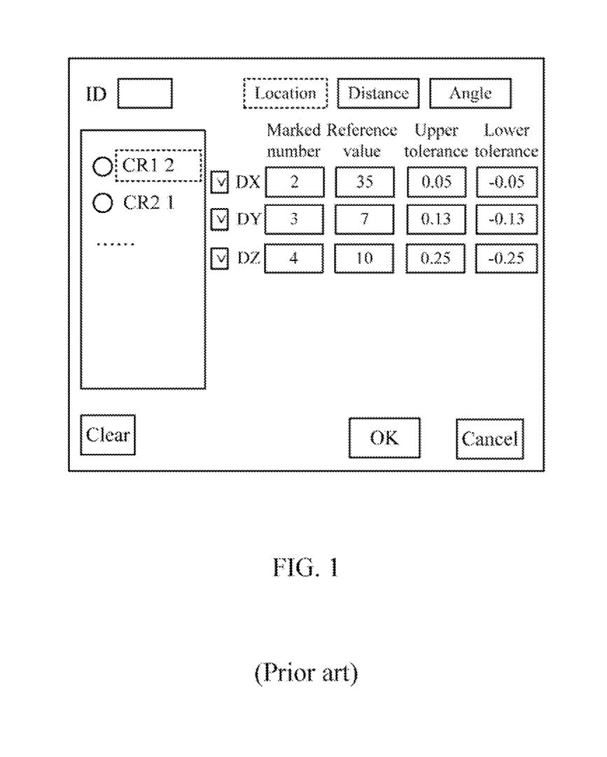

FIG. 2 is an schematic diagram of one embodiment of an electronic device including a measurement code creating system.

FIG. 3 is a schematic diagram of function modules of the measurement code creating system included in the electronic device.

FIG. 4 is a flowchart of one embodiment of a method for creating measurement codes of an object automatically using the electronic device.

FIG. 5 is an exemplary schematic diagram of a three dimensional (3D) image of an object.

FIG. 6 is an exemplary schematic diagram of determining a measurement type of one feature element.

FIG. 7 is an exemplary schematic diagram of determining measurement types of two feature elements.

FIG. 8 is an exemplary data of a measurement template file of a feature element.

FIG. 9A-9D are exemplary data of relation graphs corresponding to different measurement types.

FIG. 10 is an exemplary data of a measurement program file of the feature element.

FIG. 11 is an exemplary data of measurement codes of the feature element.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

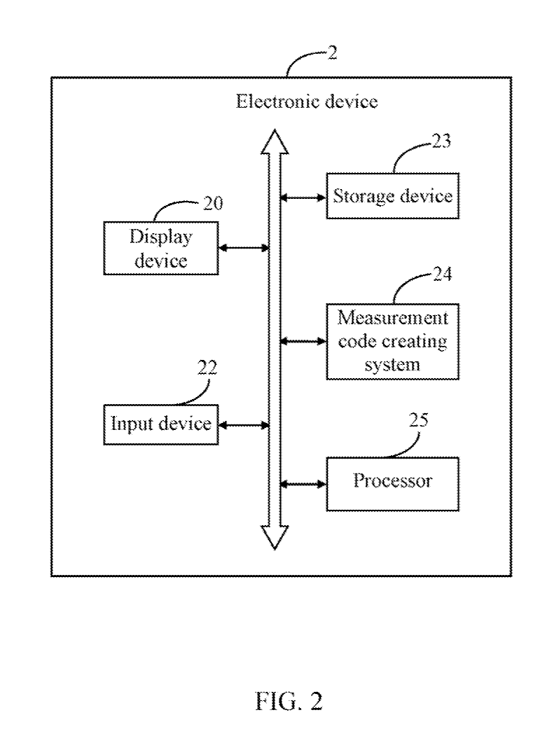

FIG. 2 is a block diagram of one embodiment of an electronic device 2 including a measurement code creating system 24. In one embodiment, the electronic device 2 further includes a display device 20, an input device 22, a storage device 23, and at least one processor 25. It should be understood that FIG. 2 illustrates only one example of the electronic device 2, which may include more or fewer components than illustrated, or a different configuration of the various components in other embodiments. The electronic device 2 may be a computer, a server, or any other computing device.

The display device 20 may be a liquid crystal display (LCD) or a cathode ray tube (CRT) display used to display measurement codes of an object, and the input device 22 may be a mouse or a keyboard used to input computer readable data. The storage device 23 may store the measurement codes of the object and other measurement data of the object.

The measurement code creating system 24 is used to receive one or more feature elements selected from a three dimensional (3D) image of an object, obtain measurement types, output axes and tolerance ranges of the feature elements, create measurement codes in relation to the feature elements, and display the measurement codes on the display device 20. In one embodiment, the feature element may be a line, a plane, a circle, a cylinder, or a sphere, but the disclosure is not limited thereto.

In one embodiment, the output axes of the feature element are specified axes (e.g., X-axis and/or Y-axis) which are used to output measurement results of the feature element. For example, if the output axis of the feature element is the X-axis, the measurement results of the feature element along the X-axis are outputted. In one embodiment, the measurement results may be a length of a feature element along the X-axis or the Y-axis. The tolerance range may be preset as a number range, for example, [−0.5, +0.5].

The measurement code creating system 24 may include computerized instructions in the form of one or more programs that are executed by the at least one processor 25 and stored in the storage device 23 (or memory). A detailed description of the measurement code creating system 24 will be given in the following paragraphs.

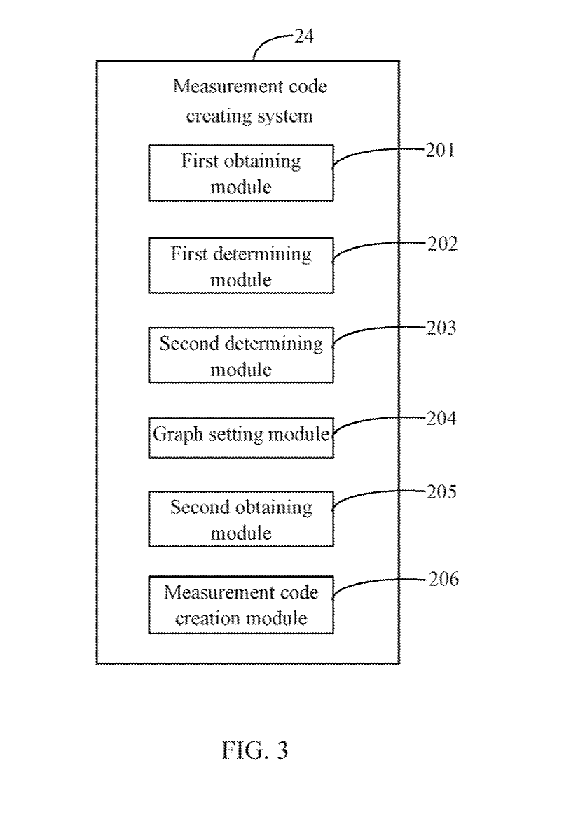

FIG. 3 is an schematic diagram of function modules of the measurement code creating system 24 included in the electronic device 2. In one embodiment, the measurement code creating system 24 may include one or more modules, for example, a first obtaining module 201, a first determining module 202, a second determining module 203, a graph setting module 204, a second obtaining module 205, and a measurement code creation module 206. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

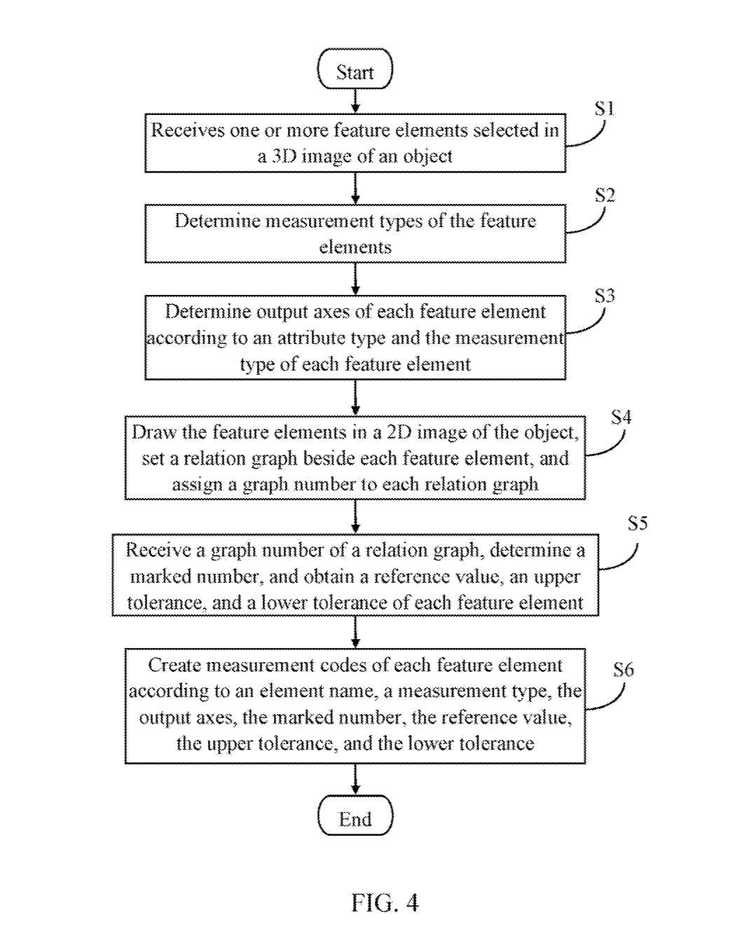

FIG. 4 is a flowchart of one embodiment of a method for creating measurement codes of an object automatically using the electronic device 2. Depending on the embodiment, additional steps may be added, others removed, and the ordering of the steps may be changed.

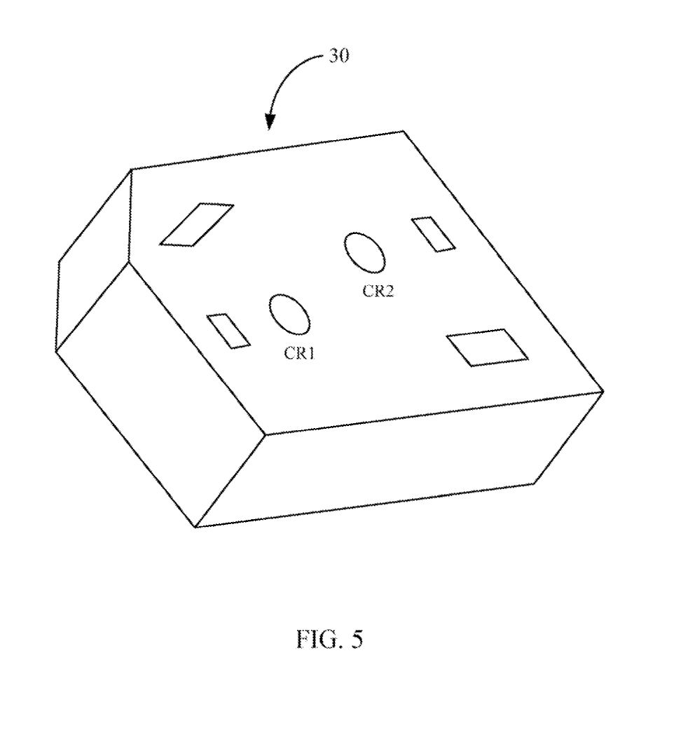

In step S1, the first obtaining module 201 receives one or more feature elements selected in a 3D image of an object in response to receiving user selections. In one embodiment, the 3D image of the object may be a computer aided design (CAD) image. For example, as shown in FIG. 5, the user may select two circles need to be measured (e.g., a first circle “CR1” and a second circle “CR2”) in a 3D image 30 of the object. “CR1” and “CR2” represent element names of the two circles.

In step S2, the first determining module 202 determines a measurement type of each of the feature elements. In one embodiment, the measurement types of the feature elements may include, but are not limited to, a distance between two adjacent feature elements, an angle between two adjacent feature elements, a location of the feature element, and form and position tolerances of the feature element. The location of the feature element may be coordinates of a center of the feature element. The form and position tolerances may include a form tolerance that is defined as a shape difference between a reference feature element and the feature element, and a position tolerance that is defined as a locational variation of the feature element as located in the object.

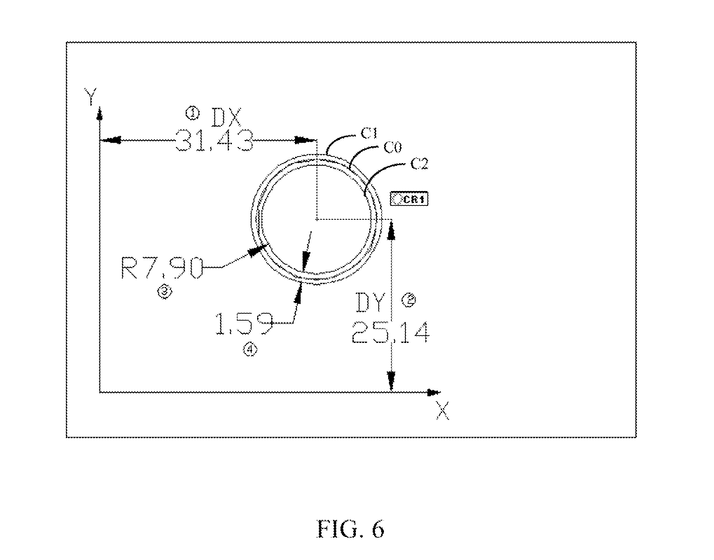

For example, as shown in FIG. 6, the user may select one feature element of a first circle “CR1”, “c0” represents an actual shape of the first circle “CR1,” “c1” represents the maximum limit of the tolerance (hereinafter referred to as “upper tolerance”) of the first circle “CR1,” and “c2” represents the minimum limit of the tolerance (hereinafter referred to as “lower tolerance”) of the first circle “CR1.” The measurement types of the first circle “CR1” may include, but are not limited to, an X-axis coordinate “DX” of a center of the first circle, a Y-axis coordinate “DY” of the center of the first circle, a radius of the first circle, and the form tolerance of the first circle.

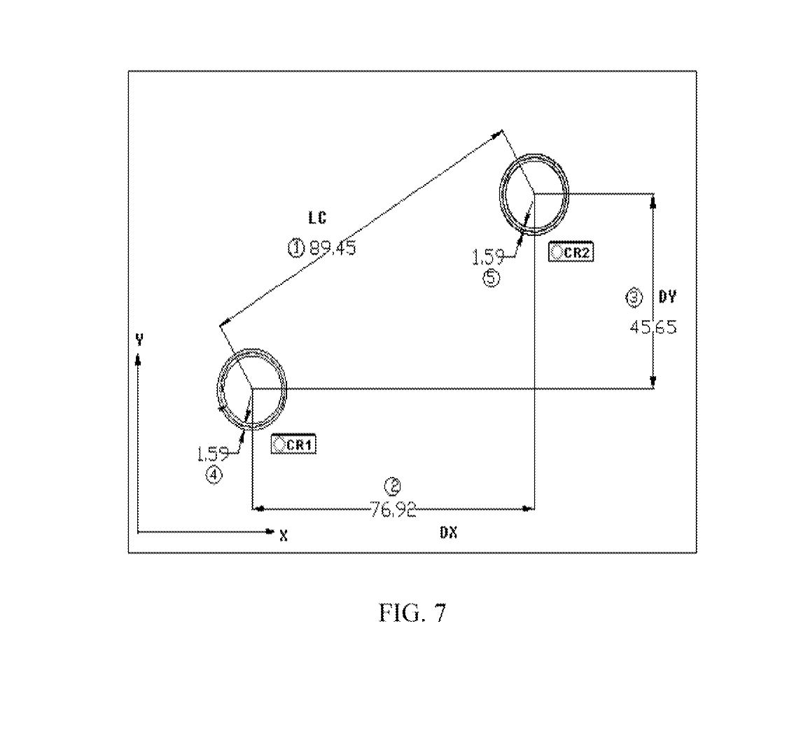

For example, as shown in FIG. 7, the user may select two feature elements, such as the first circle “CR1” and the second circle “CR2.” The measurement types of the first circle “CR1” and the second circle “CR2” may include, but are not limited to, a distance “LC” between a first center of the first circle and a second center of the second circle, an X-axis distance “DX” between the first center and the second center, a Y-axis distance “DY” between the first center and the second center, and the form tolerances of the first circle and the second circle.

In step S3, the second determining module 203 determines output axes of each feature element according to an attribute type and the measurement type of each feature element. In one embodiment, the attribute type of the feature element may be, but is not limited to, a point type, a line type, a plane type, and a circle type, for example.

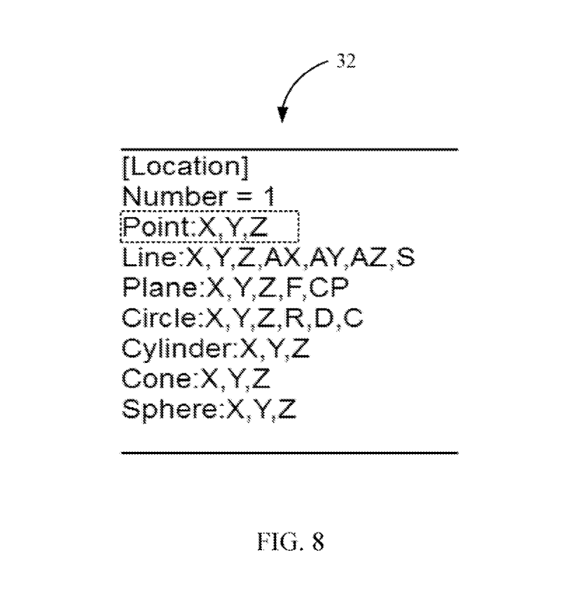

First, the second determining module 203 obtains a measurement template file of each feature element according to the measurement type of each feature element. If the measurement type of the feature element is the “Location,” an example of a measurement template file 32 is shown in FIG. 8.

Second, the second determining module 203 obtains the output axes of each feature element from the measurement template file 32 according to the attribute type of each feature element. The user may select the attribute type of the feature element as the “Point”, as shown in FIG. 8, the output axes of the feature element are determined as an X-axis, a Y-axis, and an Z-axis (refers to the broken lines).

In step S4, the graph setting module 204 draws the feature elements in a 2D image of the object, sets a relation graph (or called “relationship graph”) beside each feature element according to the measurement type of each feature element, and assigns a graph number to each relation graph. Because the feature elements are drawn in the 2D image of the object automatically, in some embodiments, there is no need to manually select the feature elements from a 2D user interface.

First, the graph setting module 204 retrieves points which provides a three-dimensional representation (i.e., point cloud(s)) of each feature element from the storage device 23.

Second, the graph setting module 204 obtains a fitted feature element (e.g., “c0” as shown in FIG. 6) by connecting the retrieved points of each feature element, and draws the upper tolerance “c1” and the lower tolerance “c2” of the fitted feature element according to a preset tolerance range (e.g., [−0.05, 0.05]). In other embodiments, the graph setting module 204 may set the fitted feature element with different colors according to the tolerances between the fitted feature element and a corresponding reference feature element.

Third, the graph setting module 204 sets a relation graph beside each fitted feature element according to the measurement type of each feature element.

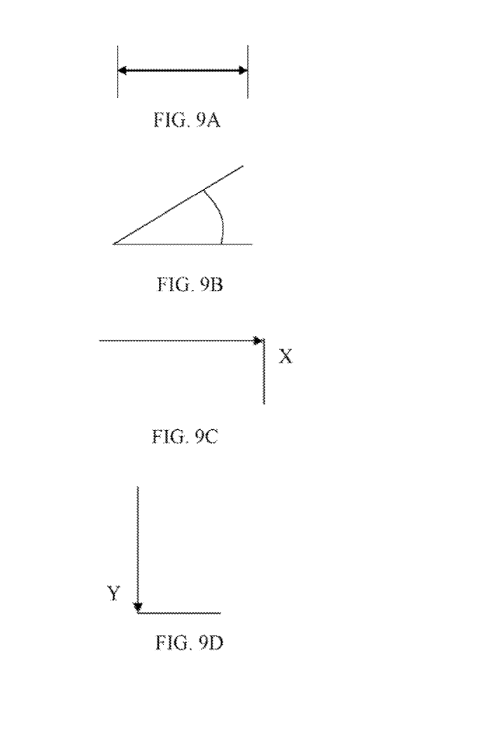

In an exemplary embodiment, if the measurement type of the feature element is the distance between two adjacent feature elements, an example of the relation graph is shown in FIG. 9A. If the measurement type of the feature element is the angle between two adjacent feature elements, an example of the relation graph is shown in FIG. 9B. If the measurement type of the feature element is the distance from the feature element to the X-axis, an example of the relation graph is shown in FIG. 9C. If the measurement type of the feature element is the distance from the feature element to the Y-axis, an example of the relation graph is shown in FIG. 9D.

Fourth, the graph setting module 204 assigns a graph number to each relation graph according to a preset sequence. In one embodiment, the preset sequence may be determined by the measurement type of the feature element as follows: the location, the distance, the angle, the form tolerance, and so on.

For example, as shown in FIG. 7, the graph number of the relation graph corresponding to the distance “LC” between the first center and the second center is assigned to be one, the graph number of the relation graph corresponding to the X-axis distance “DX” is assigned to be two, the graph number of the relation graph corresponding to the Y-axis distance “DY” is assigned to be three, the graph number of the relation graph corresponding to the form tolerance of the first circle is assigned to be four, and the graph number of the relation graph corresponding to the form tolerance of the second circle is assigned to be five.

In step S5, the second obtaining module 205 receives a graph number of a relation graph selected in the 2D image of the object in response to receiving user selections, determines a marked number corresponding to the selected graph number according to a preset configuration file, and obtains a reference value, an upper tolerance, and a lower tolerance of each feature element according to the determined marked number. In one embodiment, the marked number is a sequential or ordinal number used to identify a position of a feature element. For example, the marked number is positioned near to a corresponding feature element in the 2D image of the object, so that a user can easily find the corresponding feature element according to the marked number.

In one embodiment, the preset configuration file stores a one-to-one mapping relation between the graph numbers and the marked numbers. For example, “1-5” represents a map relation between the first graph number and the fifth marked number.

In other embodiment, the user may change the selected graph number to a target marked number manually. A detailed description of step S5 is as follows.

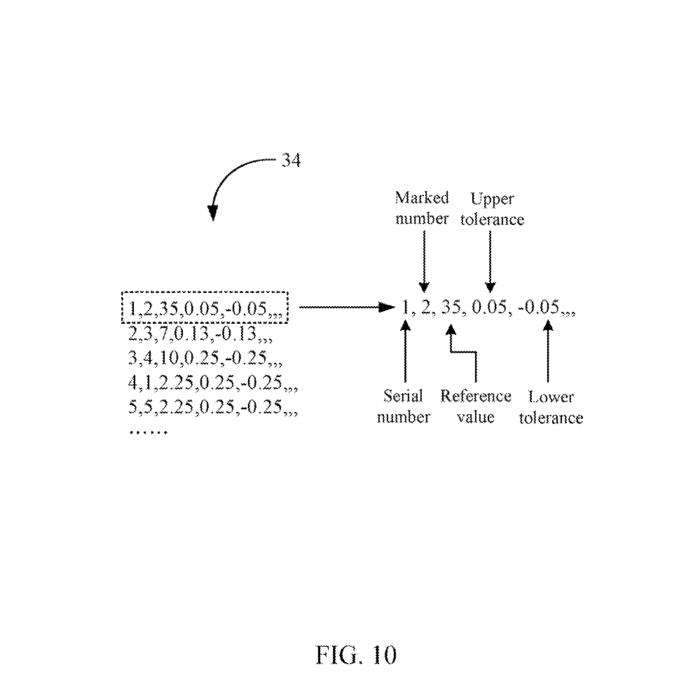

The second obtaining module 205 obtains a measurement program file 34 (as shown in FIG. 10) of each feature element from the storage device 23. The second obtaining module 205 determines measurement information corresponding to the determined marked number from the measurement program file 34, and retrieves the reference value, the upper tolerance, and the lower tolerance of each feature element from the determined measurement information. For example, as shown in FIG. 10, if the marked number is “2,” the reference value of the feature element is 35, the upper tolerance is “+0.05,” and the lower tolerance is “−0.05.” The tolerance range of the feature element determined by the lower tolerance and the upper tolerance is [−0.05, +0.05].

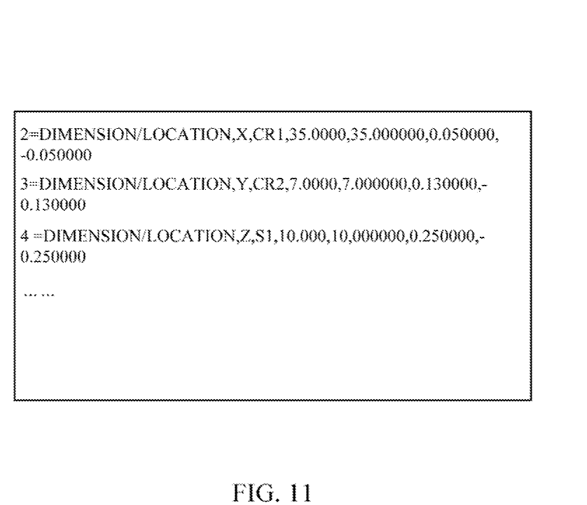

In step S6, the measurement code creation module 206 creates measurement codes of each feature element according to the element name, the measurement type, the output axes, the determined marked number, the reference value, the upper tolerance, and the lower tolerance, displays the measurement codes on the display device 20 (as shown in FIG. 11), and stores the measurement codes in the storage device 23.

An example of a format of the measurement codes of the feature element is as follows:

DimensionNo=DIMENSION/OperateType,DimensionType,ElementName,Actual, Normal,UpperTol,LowTol, where “DimensionNo” represents the determined marked number, “OperateType” represents the measurement type, “DimensionType” represents the output axes, “ElementName” represents the element name, “Actual” represents the measured results, “Normal” represents the “reference value,” “UpperTol” represents the upper tolerance, and “LowTol” represents the lower tolerance.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized-implemented method for creating measurement codes using an electronic device comprising a processor, the method comprising:
receiving feature elements selected in a three dimensional (3D) image of an object;
determining measurement types of the feature elements;
determining output axes of each of the feature elements according to an attribute type and the measurement type of each of the feature elements;
drawing the feature elements in a two dimensional (2D) image of the object, setting a relation graph beside each of the feature elements according to the measurement type of each of the feature elements, and assigning a graph number to each relation graph;
determining a graph number of a relation graph selected in the 2D image of the object, determining a marked number corresponding to the selected graph number, and obtaining a reference value, an upper tolerance, and a lower tolerance of each of the feature elements according to the determined marked number; and
creating measurement codes of each of the feature elements according to an element name, the measurement type, the output axes, the marked number, the reference value, the upper tolerance, and the lower tolerance of each of the feature elements, and storing the measurement codes in a storage device of the electronic device.

2. The method according to claim 1, wherein the attribute types of the feature elements are selected from the group consisting of a point type, a line type, a plane type, and a circle type.

3. The method according to claim 1, wherein the measurement types of the feature elements are selected from the group consisting of a distance between two adjacent feature elements, an angle between two adjacent feature elements, and a location of each of the feature elements.

4. The method according to claim 1, wherein the output axes of each of the feature elements are determined by:
obtaining a measurement template file of each of the feature elements according to the measurement type of each of the feature elements; and
obtaining the output axes of each of the feature elements from the measurement template file according to the attribute type of each of the feature elements.

5. The method according to claim 1, wherein the relation graph and the graph number are obtained by:
retrieving points of each of the feature elements from the storage device;
obtaining a fitted feature element by connecting the retrieved points of each of the feature elements, and drawing the upper tolerance and the lower tolerance of the fitted feature element according to a preset tolerance range;
setting a relation graph beside each fitted feature element according to the measurement type of each of the feature elements; and
assigning a graph number to each relation graph according to a preset sequence.

6. The method according to claim 1, wherein the reference value, the upper tolerance, and the lower tolerance of each of the feature elements are obtained by:
obtaining a measurement program file of each of the feature elements from the storage device; and
determining measurement information corresponding to the determined marked number from the measurement program file, and retrieving the reference value, the upper tolerance, and the lower tolerance of each of the feature elements from the determined measurement information.

7. The method according to claim 1, wherein the marked number corresponding to the selected graph number is determined according to a preset configuration file, the preset configuration file storing a one-to-one mapping relation between the graph numbers and the marked numbers.

8. The method according to claim 1, wherein the output axes of each feature element are specified axes for outputting measurement results of each of the feature elements.

9. An electronic device, comprising:
a storage device;
at least one processor; and
one or more modules that are stored in the storage device and executed by the at least one processor, the one or more modules comprising:
a first obtaining module that receives feature elements selected in a three dimensional (3D) image of an object;
a first determining module that determines measurement types of the feature elements;
a second determining module that determines output axes of each of the feature elements according to an attribute type and the measurement type of each of the feature elements;
a graph setting module that draws the feature elements in a two dimensional (2D) image of the object, sets a relation graph beside each of the feature elements according to the measurement type of each of the feature elements, and assigns a graph number to each relation graph;
a second obtaining module that determines a graph number of a relation graph selected in the 2D image of the object, determines a marked number corresponding to the selected graph number, and obtains a reference value, an upper tolerance, and a lower tolerance of each of the feature elements according to the determined marked number; and
a measurement code creation module that creates measurement codes of each of the feature elements according to an element name, the measurement type, the output axes, the marked number, the reference value, the upper tolerance, and the lower tolerance of each of the feature elements, and stores the measurement codes in the storage device.

10. The electronic device according to claim 9, wherein the attribute types of the feature elements are selected from the group consisting of a point type, a line type, a plane type, and a circle type.

11. The electronic device according to claim 9, wherein the measurement types of the feature elements are selected from the group consisting of a distance between two adjacent feature elements, an angle between two adjacent feature elements, and a location of each of the feature elements.

12. The electronic device according to claim 9, wherein the second determining module determines the output axes of each of the feature elements by:
obtaining a measurement template file of each of the feature elements according to the measurement type of each of the feature elements; and
obtaining the output axes of each of the feature elements from the measurement template file according to the attribute type of each of the feature elements.

13. The electronic device according to claim 9, wherein the graph setting module sets the relation graph and the graph number by:
retrieving points of each of the feature elements from the storage device;
obtaining a fitted feature element by connecting the retrieved points of each of the feature elements, and drawing the upper tolerance and the lower tolerance of the fitted feature element according to a preset tolerance range;
setting a relation graph beside each fitted feature element according to the measurement type of each of the feature elements; and
assigning a graph number to each relation graph according to a preset sequence.

14. The electronic device according to claim 9, wherein the second obtaining module obtains the reference value, the upper tolerance, and the lower tolerance of each of the feature elements by:
obtaining a measurement program file of each of the feature elements from the storage device; and
determining measurement information corresponding to the determined marked number from the measurement program file, and retrieving the reference value, the upper tolerance, and the lower tolerance of each of the feature elements from the determined measurement information.

15. The electronic device according to claim 9, wherein the marked number corresponding to the selected graph number is determined according to a preset configuration file, the preset configuration file storing a one-to-one mapping relation between the graph numbers and the marked numbers.

16. The electronic device according to claim 9, wherein the output axes of each of the feature elements are specified axes for outputting measurement results of each of the feature elements.

17. A non-transitory storage medium having stored thereon instructions that, when executed by a processor of an electronic device, causes the electronic device to perform a method for creating measurement codes, the method comprising:
receiving feature elements selected in a three dimensional (3D) image of an object;
determining measurement types of the feature elements;
determining output axes of each of the feature elements according to an attribute type and the measurement type of each of the feature elements;
drawing the feature elements in a two dimensional (2D) image of the object, setting a relation graph beside each of the feature elements according to the measurement type of each of the feature elements, and assigning a graph number to each relation graph;
determining a graph number of a relation graph selected in the 2D image of the object, determining a marked number corresponding to the selected graph number, and obtaining a reference value, an upper tolerance, and a lower tolerance of each of the feature elements according to the determined marked number; and
creating measurement codes of each of the feature elements according to an element name, the measurement type, the output axes, the marked number, the reference value, the upper tolerance, and the lower tolerance of each of the feature elements, and storing the measurement codes in a storage device of the electronic device.

18. The non-transitory storage medium according to claim 17, wherein the output axes of each of the feature elements are determined by:
obtaining a measurement template file of each of the feature element according to the measurement type of each of the feature elements; and
obtaining the output axes of each of the feature elements from the measurement template file according to the attribute type of each of the feature elements.

19. The non-transitory storage medium according to claim 17, wherein the reference value, the upper tolerance, and the lower tolerance of each of the feature elements are obtained by:
obtaining a measurement program file of each of the feature elements from the storage device; and
determining measurement information corresponding to the determined marked number from the measurement program file, and retrieving the reference value, the upper tolerance, and the lower tolerance of each of the feature elements from the determined measurement information.

20. The non-transitory storage medium according to claim 17, wherein the marked number corresponding to the selected graph number is determined according to a preset configuration file, the preset configuration file storing a one-to-one mapping relation between the graph numbers and the marked numbers.
